(19) United States
(12) Patent Application Publication
(10) Pub. No.: US 2023/0276542 A1
(43) Pub. Date: Aug. 31, 2023

(54) GLASS PRODUCT, METHOD OF APPLYING CONNECTOR TO GLAZING, AND CONNECTOR

(71) Applicant: CARLEX GLASS AMERICA, LLC, Nashville, TN (US)

(72) Inventors: Wladislaw BRONSTEIN, Trier (DE); Olivier FARREYROL, Wasserbillig (LU); Jacob Daniel RIGELMAN, Garrett, IN (US); Michael BARD, Wadern (DE)

(21) Appl. No.: 18/014,082

(22) PCT Filed: Jul. 1, 2021
(86) PCT No.: PCT/US2021/040121

§ 371 Date: Dec. 30, 2022

Related U.S. Application Data
(60) Provisional application No. 63/047,660, filed on Jul. 2, 2020.
(60) Provisional application No. 63/047,700, filed on Jul. 2, 2020.

(51) Int. Cl. H05B 3/84; H01R 12/57; H01R 4/04

(52) U.S. Cl. CPC H05B 3/84; H01R 4/04; H01R 12/57

(57) ABSTRACT

A glass product, comprising: a glazing having a connectable material with a connecting surface thereon; a connector over the connecting surface including a housing and a connector plate within the housing; and a conductive material within the housing, wherein the connector plate is spring loaded.

### CROSS REFERENCE TO RELATED APPLICATIONS

This application claims priority to U.S. Provisional Application No. 63/047,660, filed on Jul. 2, 2020, entitled “Electrical Connector,” and U.S. Provisional Application No. 63/047,700, filed on Jul. 2, 2020, entitled “Electrical Connector,” the entire contents of which are incorporated by reference herein in their entireties.

### TECHNICAL FIELD

The present disclosure generally relates to glass products, electrical connectors, and methods of applying such electrical connectors to a glazing.

### BACKGROUND

Traditionally, electrical connectors have been soldered to electrically conductive materials in automotive glass via lead-containing solder. However, new directives have instituted use of lead-free solders, which have proven difficult, as mechanical stresses at the connectors lead to cracks in an underlying glass. U.S. Pat. No. 9,520,665 (the ‘665 patent) discloses an electrical connector attached to a glass plate with a conductive rubber at least partially surrounded by a thermosetting adhesive on the underside of the connector. The process described in the ‘665 patent uses heat and pressure from an autoclaving process during glass lamination to adhere the connector to glass.

### SUMMARY OF THE DISCLOSURE

Disclosed herein is a glass product including: a glazing having a connectable material with a connecting surface thereon; a connector over the connecting surface including a housing, a connector plate within the housing, and an extension which extends from the connector plate through the housing; and a conductive material within the housing, wherein the connector plate is spring loaded.

In some embodiments of the present disclosure, the extension may be a wire connection.

In some embodiments of the present disclosure, at least a part of the connector plate may be buried in the conductive material. The housing may include at least one opening that is sealed. In some further embodiments, a non-conductive material may be within the housing.

In some embodiments of the present disclosure, the connector plate does not contact the connecting surface. In other embodiments, the connector plate may directly contact the connecting surface. There may be no air pockets within the housing and the housing may have no sharp corners within the housing interior.

In another aspect of the present disclosure, a method of applying a connector to a glazing having a connectable material includes: positioning a conductive material on a connecting surface for the connectable material on the glazing; positioning the connector including a housing and a connector plate within the housing on the glazing to enclose the conductive material so that the connector plate is spring loaded.

In another aspect of the present disclosure, a method of applying a connector to a glazing having a connectable material includes: placing the connector including a housing and a connector plate within the housing a connecting surface for the connectable material on the glazing so that the connector plate is spring loaded; filling the housing with a conductive material through an opening in the housing; and sealing the opening and a bottom edge of the housing.

In some embodiments, there may be no air pocket in the connector applied to the glazing. The housing may include an adhesive on a bottom surface of the housing. The adhesive may be a pressure sensitive adhesive or an ultraviolet light curable adhesive. The method may further include sealing a vent opening in the housing.

### BRIEF DESCRIPTION OF THE DRAWINGS

The accompanying drawings, which are incorporated into and constitute a part of this specification, illustrate one or more aspects of the present disclosure and, together with the detailed description, serve to explain their principles and implementations.

FIG. 1 is a cross section showing a connector, according to an embodiment of the present disclosure;

FIG. 2 is a cross section showing a connector, according to an embodiment of the present disclosure;

FIG. 3 is a cross section showing a glass product, according to an embodiment of the present disclosure;

FIG. 4 is a cross section showing a glass product, according to an embodiment of the present disclosure;

FIG. 5 is a cross section showing a glass product, according to an embodiment of the present disclosure;

FIG. 6 is a cross section showing a method of applying a connector to a glazing, according to an embodiment of the present disclosure;

FIG. 7 is a cross section showing a method of applying a connector to a glazing, according to an embodiment of the present disclosure;

FIG. 8 is a cross section showing a connector, according to an embodiment of the present disclosure;

FIG. 9 is a cross section showing a glass product, according to an embodiment of the present disclosure;

FIG. 10 is a cross section showing a method of applying a connector to a glazing, according to an embodiment of the present disclosure;

FIG. 11 is a cross section showing a method of applying a connector to a glazing, according to an embodiment of the present disclosure; and

FIG. 12 is a cross section showing a glass product, according to an embodiment of the present disclosure.

### DETAILED DESCRIPTION

In the following description, for purposes of explanation, specific details are set forth in order to promote a thorough understanding of one or more aspects of the disclosure. It may be evident in some or all instances, however, that many aspects described below can be practiced without adopting the specific design details described below.

Disclosed herein is a glass product including a glazing having a connectable material thereon; a connector over the connectable material at a connecting surface including a housing and a connector plate within the housing; and a conductive material within the housing, wherein the connector plate is spring loaded.

Glass products, including automotive glass products, may include glazings and connectors where power is to be supplied to the glazing or an element of the glazing. Particularly, a coating or print may be powered, for example, to be heated. Printed silver, for example, may be located across a glazing, such as heating lines across a rear window, or in a localized area, such as wiper park heating lines. Coatings or printings may require a connector to provide power from an electrical source to heat the coating or print. Antennas, likewise, may require a connector to reach a signal receiver. A connector may be attached to an outer surface of the glazing, such that in a laminated glazing, the connector may be attached without regard for timing of an autoclave process. In some glazings, a connectable material may be provided on a glazing interior surface and include a glass cutout which may allow for a connector to be attached after the glazing is laminated. Further, some glazings may not be laminated. For example, a rear window may be a tempered glass substrate that is not laminated. Among other things, a method of applying a connector, as disclosed herein, may advantageously work for both laminated and non-laminated glazings.

An automotive glazing may include a coating or print of material which may be electrically connectable. Coatings may, for example, include metals, such as silver, or conductive oxides. In some embodiments, the electrically connectable materials may be printed onto the glazing, including by screen printing. For example, silver, or silver alloy, material may be screen printed onto a glass substrate, such as lines across a rear window for heating and melting snow and ice on the window. Printed electrically connectable materials may further be provided in an area of a windshield or rear window where a wiper may sit in an off position. Such a “wiper park” may include a printed silver which is heatable by connection to a power supply. A printed connectable material may be any suitable pattern to provide adequate heating or power to a desired area or areas and may include an area printed for connecting to an electrical connector. In some embodiments, the glazing may include an opaque print at a periphery and/or around an accessory, such as a camera or sensor, and the silver may be printed on the glass and/or an opaque print. The connectable print may include a connecting surface which is to be connected to a connector.

A connector may provide a conductive attachment between a power source or receiver and a connectable material. Particularly, a connectable material formed on a glazing may include a busbar or other connecting surface. A connecting surface may include a busbar or another surface for attaching a connector to a connectable material. A busbar may be any suitable form, such as a silver-containing material and/or a metallic tape, such as a copper tape. A copper tape may be positioned over other connectable materials and form a suitable surface for attaching a connector for attaching to a power source. A busbar may be formed on some glazings as a silver printed busbar. A busbar may be formed to connect a coating, a printed silver layer, an antenna, or any other suitable material to a connector. In some glazings, the busbar may be printed on a black frit on a glass substrate.

In certain embodiments described herein, a connector may be provided which includes a housing and a connector plate within the housing, wherein the connector plate has a spring capacity. A conductive material may be used within the housing, preferably between a connecting surface on a glazing and the connector plate to properly connect the materials and provide a suitable contact between the materials. The conductive material may increase the area of the connector plate that is in electrical contact with the connecting surface and improve the connection therebetween. The connector plate may come into direct contact with the connecting surface at one or more points in some embodiments. In some embodiments, the conductive material covers the connecting surface within the housing such that the connector plate does not physically contact the connecting surface. The connector plate may preferably be positioned against the conductive material, where pressure from the connector plate may provide pressure against the conductive material. The connector plate may be attached to the housing on one end, such that the connector plate is held in contact with the housing. The other end of the connector plate may be free such that it is not in a fixed position with relation to the housing. The connector plate may have any suitable form, such as a wire or plate, and shape, which may include a shape matching the glazing surface shape. The connector plate may be a plate spring. A matching shape between the glazing and connector plate may reduce inhomogeneities of thickness of the conductive material, which may improve conductivity and reduce a risk of creating a hot spot. The connector plate may be formed, including in its shape, such that it may exert pressure against a connecting surface and/or a conductive material formed under the connector plate when installed on a glazing. When the connector housing is positioned on the glazing, the connector plate may be spring loaded such that it may flex against a connecting surface or a conductive material on the glazing, which may provide pressure against the connectable material or the conductive material from the connector plate. A part of the connector plate may be in contact with the connectable material. Prior to installation, part of the connector plate may extend below a bottom surface of the housing. Sharp edges of the connector plate which may contact a glazing may preferably be avoided. Thus, in some preferable embodiments the free end of the connector plate may have smooth edges. In some embodiments, the free end of the connector plate may be attached to the housing. The connector plate may have flexibility even where attached to the housing so that it may flex against a connecting surface or a conductive material on the glazing.

In another embodiment, the glass product may further include a non-conductive material within the housing. In such an embodiment, at least a part of the conductive material may be positioned between the connectable material and the connector plate to suitably connect the materials, and it may not be necessary to completely fill the housing interior with the conductive material. The non-conductive material may be further provided in the housing to fill the remaining space, e.g., space between the conductive material and a housing ceiling. The non-conductive material may apply pressure to the conductive material when it is applied on top of the conductive material. Preferably, the non-conductive material may expand within the housing. The expansion may induce pressure against the connector plate, towards the connecting surface, as the non-conductive material is positioned above the connector plate. An expanding non-conductive material may include, for example, a polyurethane foam. A seal may be formed on a housing opening where a non-conductive material is administered directly after the non-conductive material is placed within the housing. A vent opening may further be provided in the housing where non-conductive material is administered through an opening and the vent opening may also be sealed directly after non-conductive material is placed in the housing. The conductive material in the housing may fill around a connector plate within the housing such that a bottom and top of the connector plate may be in contact with the conductive material. In some embodiments, the connector plate may be partially or entirely covered on a top surface by the non-conductive material.

Preferably, the conductive material and the non-conductive material completely fill the housing such that there are no air pockets in the housing. The conductive material may include metal particles which may be costly as compared to non-conductive filling materials free of such conductive particles. Thus, it may be preferably, in some embodiments, to fill the housing, above a conductive material, with a non-conductive material. Particularly, the non-conductive material may be a polyurethane resin, silicone resin, metal oxide, or elastomer, such as a paste or particles. Preferably, the non-conductive material may not mix with the conductive material within the housing, such that conductive particles in the conductive material may not migrate to the non-conductive material. It may be preferable to keep the materials separate, such that the conductivity of the conductive material is not reduced by such migration. The non-conductive material may further function as a seal at an opening of the housing. Where the non-conductive material is a seal, an additional seal material may not be required at the housing opening.

The connector plate may have an extension which may extend out of the housing. The extension may be used to connect the connector plate to a power source or receiver and may thus be formed with a conductive material. The extension may be formed as a single piece with the connector plate or may be attached to the connector plate. Where the extension is attached to the connector plate, the extension may be attached by any suitable means, including welding, soldering, crimping, riveting, etc. In some embodiments, an extension may extend from the connector plate through an opening in the housing. The extension may be a wire connection. The extension may be formed in any suitable direction. The extension may extend out of the housing either vertically through a ceiling of the housing or horizontally through a side wall of the housing. The extension may extend through an opening for filling the housing with a conductive material and/or non-conductive material, a vent opening, or through another opening. The direction of the extension may be determined to provide a suitable connection point for attachment to a power source.

A suitable housing material may be a nonconductive material, including a plastic such as polycarbonate. The housing may have sufficient strength such that the housing may not change in shape under pressure of conductive material filled therein. The connector plate may be a material having suitable conductivity with a conductive strength such that a power source may be adequately attached thereto and provide sufficient conductivity to transfer electrical voltage from the power source to the connectable material or to provide a signal to a receiver. For example, the connector plate may include copper, iron, aluminum, nickel, or alloys including such metals. An extension on the connector plate may be electrically conductive such that the extension may electrically connect the connector plate to a power source or a receiver. The extension may, in some embodiments, be the same material as the connector plate. In some embodiments, the extension may be a conductive wire, which may include a nonconductive insulative coating around such wire.

Where the connector described herein is applied to a glazing, a conductive material may be positioned at least partially between the connector plate and a connecting surface on the glazing. The conductive material may be any suitable material, including having a suitable electrical resistance. Particularly, the conductive material may include: a metal such as silver, copper, or aluminum; metal-containing material such as an alloy; or a carbon material such as graphite or carbon nanotube. The conductive material may be applied in a form of a paste. For example, a silver paste may be usable as a conductive material. A medium may contain 2-(2-ethoxyethoxy)ethyl acetate and other components similar to automotive silver paste. Silver concentration range may be 50 to 90 wt%, preferably 80 to 90 wt%, even more preferably 85 to 90 wt%. Viscosity may be 5000-100000 cP(or mPa.s) at 25° C., preferably 9000-35000 cP (or mPa.s) at 25° C., measured by a rheometer, such as Brookfield DVIII, SC4-14/6R at 20 rpm. Sheet resistivity of a silver paste may be 1-10 mΩ/sq at 25 µm, preferably 7-8mΩ/sq at 25 µm. A solder paste may be usable as a conductive material. It may contain metallic solder alloy powder like SAC alloy [tin-silver-copper] with flux type Ro10, resin flux. This may be more cost effective than silver paste. The particle size of SAC powder in the flux may be 1-100 µm, preferably 15 to 45 µm. Metal content in the solder paste may be 50 to 90 wt%, preferably 85 to 90 wt%. Viscosity may be 10000-1000000 cP (mPa.s), preferably 100000-900000 cP (mPa.s). In some embodiments, the conductive material may be compressible such that, under pressure, the conductive material may compress and form a strong electrical connection between an underlying connecting surface, such as a busbar, and the connector plate.

Connectors described herein may be applied to a glazing having a conductive material thereon. In some embodiments, a conductive material, such as a metallic paste or alloy, may be positioned on a connecting surface, an area on the glazing for connector attachment, such as a busbar, in an amount to form a suitable connection with the connector plate. In some embodiments, the conductive material may be in an amount to completely cover the bottom surface of the connector plate. The electrical connector described herein may be placed over the connecting surface such that the connector plate is aligned with a desired connection area on the glazing. At least a part of the connector plate may be buried in the conductive material. The connector plate may be flexed against the glazing, with the conductive material therebetween, as the connector housing is positioned on the glazing. In some embodiments, the amount of conductive material used may be sufficient to extend above the connector plate within the housing and may fill the housing. The housing interior may have a width greater than a width of the connector plate such that there is space for the conductive material to fill around the edges of the connector plate and fill above the connector plate.

The connector may include an adhesive on a bottom surface of the housing. The adhesive may be a pressure sensitive adhesive, a temperature curable adhesive, or an ultraviolet light curable adhesive. The housing may be adhered to the glazing, particularly at a connecting surface on the glazing. An adhesive sealing material may be used around and/or under a bottom edge of the housing to adhere the housing to the glazing and to seal the edge between the materials. Where the adhesive is provided on the bottom of the housing, as the housing is positioned on the glazing, the adhesive may partially spill out from underneath the housing so that the adhesive is under the housing and at an edge of the housing where the housing meets the glazing. The shape of the housing bottom surface may be designed to allow spilling out outside of the housing rather than inside of the housing. For example, the bottom surface may be higher on an outside edge compared to an inside edge of the housing bottom surface. Some housings may include a bottom surface that has a recess for placement of the adhesive. The shape of the housing bottom may be selected, at least in part, by the viscosity of the adhesive. In some embodiments, adhesives may be applied at each of the bottom of the housing and around an edge of the housing. An adhesive applied to the bottom of the housing may be the same or different from an adhesive applied around a bottom edge of the housing. Applying an adhesive around the edge of the housing where it meets the glazing may improve strength against peeling. The spilling out of adhesive or additional adhesive may further improve protection against moisture or chemicals for the materials within the housing. The seal may have suitable mechanical strength to maintain the housing in position on the glazing. The adhesive may be an ultraviolet light (UV) curable adhesive, a temperature curable adhesive, or a pressure sensitive adhesive. An adhesive tape may be used as such a seal around the housing edge or on a bottom surface of the housing edge. Such a tape may be a double sided adhesive tape. In some embodiments, the housing material may be transparent to UV light which may be used for curing an adhesive under the housing. The adhesive may be, for example, polyurethane resin, epoxy resin, methacrylic resin or silicone resin.

In some embodiments, an adhesive may be provided on the bottom edge of the housing and a release liner may cover the adhesive. The liner may be removed before the connector housing is positioned on a glazing. Thus, a connector may include a housing; a connector plate within the housing; an adhesive on the bottom of the housing; and a film on a bottom surface of the housing.

Where the housing is provided having an opening, the opening though the housing may further be sealed such that conductive material within the housing is not exposed to ambient conditions. The seals may prevent moisture and chemicals from reaching conductive material within the housing. The conductive material and/or non-conductive material may completely fill the housing such that there are no air pockets in the sealed housing. The housing interior may have rounded surfaces without sharp corners to minimize possibility of air pockets within the housing. The conductive material and/or non-conductive material may be filled through an opening in the housing. A second opening may be provided in the housing as a vent to allow for air to leave the housing interior as conductive material or non-conductive material is administered into the housing. The opening through the housing and any vent opening may be sealed after the conductive material and any non-conductive material are positioned within the housing and the connector plate is in position, which may be when the housing is positioned and adhered to the connecting surface on a glazing. The seal may be polyurethane resin, epoxy resin, methacrylic resin or silicone resin and may be same or different from a seal positioned below or at the edge of the housing.

In another embodiment of the glass product, the glass product may include a connector on a glazing having a plurality of connecting surfaces thereon. The connector may have a multiple-compartment housing having at least two independent compartments, each of which includes a connector plate and a conductive material. Each compartment is electrically isolated from other compartments such that the connector plates remain electrically isolated from each other. The housing material may be non-conductive such that the compartments may remain electrically isolated from each other. Where the housing separates the compartments, a seal, which may include adhesive between the compartments may not allow the migration of conductive material such that the seal retains electrically isolated compartments. Each connector plate may have an extension as described above and may be electrically connected to an underlying connecting surface. A conductive material may be positioned at least partially between the connector plate and the connecting surface. In some embodiments, a non-conductive material may further be provided within the housing to fill the space in each compartment of the housing.

Disclosed herein is a method of applying a connector to a glazing including: positioning a conductive material on a connecting surface on the glazing; positioning the connector including a housing and a connector plate within the housing on the glazing to enclose the conductive material so that the connector plate is spring loaded. Prior to placing the connector on a connecting surface, the connecting surface may be cleaned; for example, silver print may be burnished. The connector housing may include a vent opening for removal of air as the connector is positioned. The vent opening may be sealed once the housing is in place over the conductive material.

Disclosed herein is another method of applying a connector to a glazing including: placing the connector including a housing and a connector plate within the housing on a connecting surface so that the connector plate is spring loaded; filling the housing with a conductive material through an opening in the housing; and sealing the opening and a bottom edge of the housing. Prior to placing the connector on a connecting surface, the connecting surface may be cleaned; for example, silver print may be burnished. When the glass product further includes a non-conductive material within the housing, the method may further include filling the housing with a non-conductive material through the opening in the housing after the filling the housing with the conductive material.

In some embodiments, the connector may be applied to a glazing prior to treatment in an autoclave. The height of such a connector may preferably be limited. An autoclave may have a controlled size for the inclusion of glazings to be autoclaved. Adding to the thickness of the glazings, including with materials positioned on the glazings, may reduce the number of glazings which may fit within an autoclave. Where the connector is applied to a glazing prior to an autoclave treatment, the connector may have a height of preferably 30 mm or less, more preferably 20 mm or less.

The connectors and methods disclosed herein may be used without the addition of heat to a glazing, particularly where the housing is attached to a glazing using a pressure sensitive adhesive or a UV curable adhesive. Without heat, some heat sensitive materials may be used in such connectors and the connection methods may avoid thermal damage to a glazing. Further, the connectors may be applied without the use of an autoclave, such that they may be used for laminated and nonlaminated glazings.

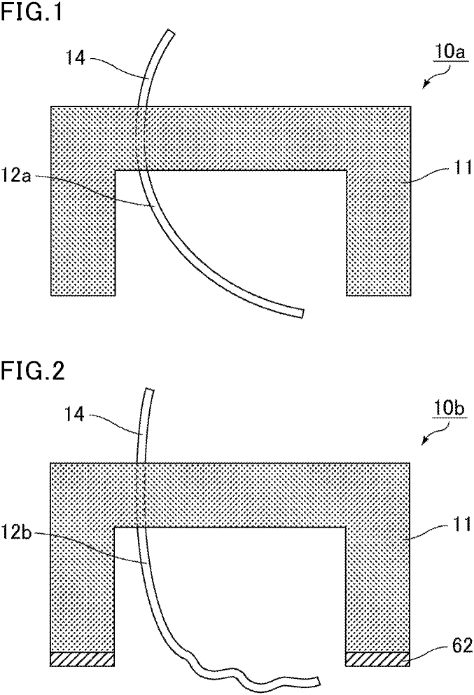

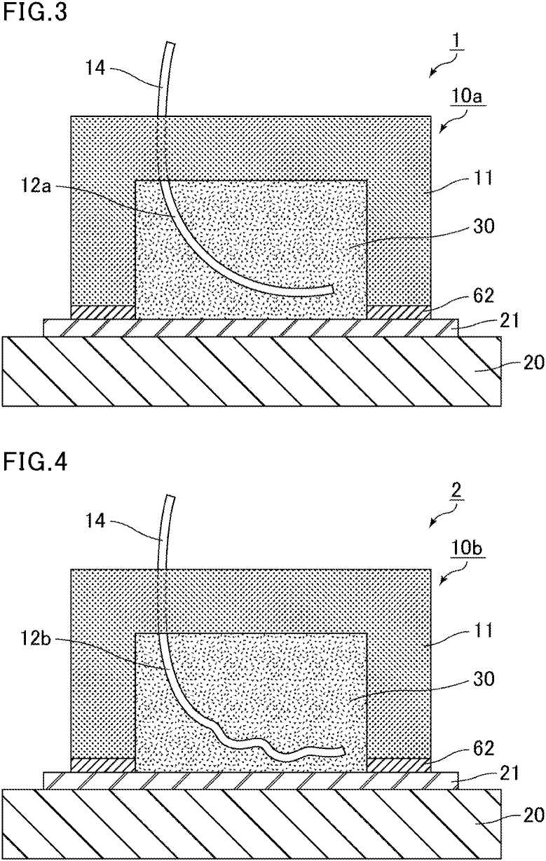

FIGS. 1 and 2 illustrate connectors 10a and 10b according to some embodiments disclosed herein. As shown, each of the connector plates 12a and 12b may have an attached end and a free end. The free end of the connector plate may have any suitable shape. For example, different possible shapes are shown in FIGS. 1 and 2. Some connector plates, such as connector plate 12b shown in FIGS. 2 and 4, may have feet which extend towards the glazing surface when installed on a glazing 20. Each of the connector plates 12a and 12b may have an extension 14 which extends from the connector plate 12a or 12b out of the housing 11. The extension 14 may further have any suitable shape and form to attach to a power source or a receiver. An adhesive 62 may be provided on the bottom edge of the housing 11. FIGS. 3 and 4 illustrate glass products 1 and 2 respectively having connectors 10a and 10b attached to connecting surfaces 21 on the glazings 20. The connector housing 11 is adhered to the connectable material 21 on the glazing 20 via adhesive 62. Conductive material 30 are within the housings 11 and between the connector plates 12a and 12b and the connecting surfaces 21. As shown, the housing interior may have no air pockets. The connector plates 12a and 12b may be in a flexed position within the housing 11 when applied on the glazing 20.

FIG. 5 illustrates a glass product 3 having a connector 10a attached to connecting surface 21 on the glazing 20. The connector housing 11 is adhered to the connecting surface 21 on the glazing 20. An adhesive 62 may be provided on the bottom edge of the housing 11. The connector plate 12a may have an extension 14 which extends from the connector plate 12a out of the housing 11. As shown, the housing interior is filled with a conductive material 30 and a non-conductive material 40 and may have no air pockets. The non-conductive material 40 fills the space between the conductive material 30 and a housing ceiling. A seal 16 is used to close an opening 15 in the housing 11 and may be formed at a housing opening 15 and around an extension 14 which may pass through such an opening. In some embodiments, the extension 14 may extend from the housing in one position and an opening for filling the housing with conductive material or non-conductive material may be separate from the extension. Further, some embodiments may also include a vent opening which may be sealed as well.

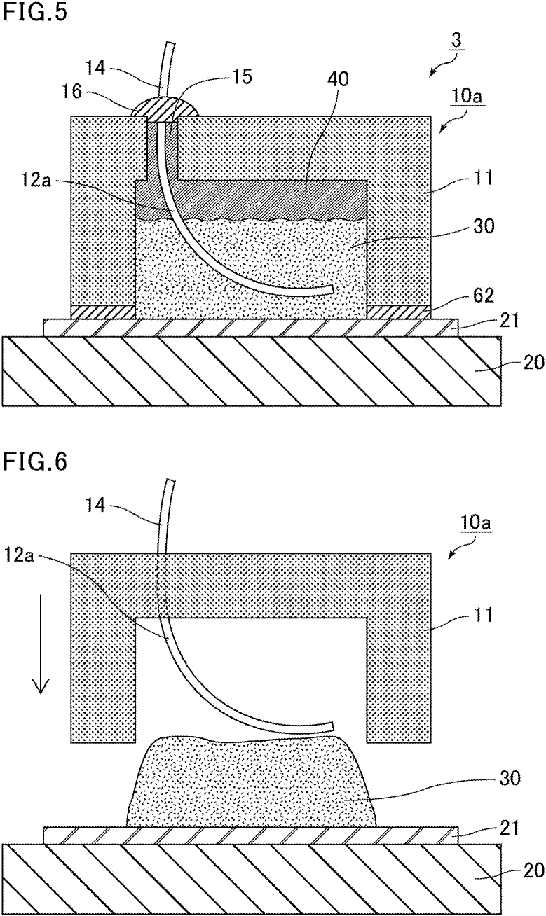

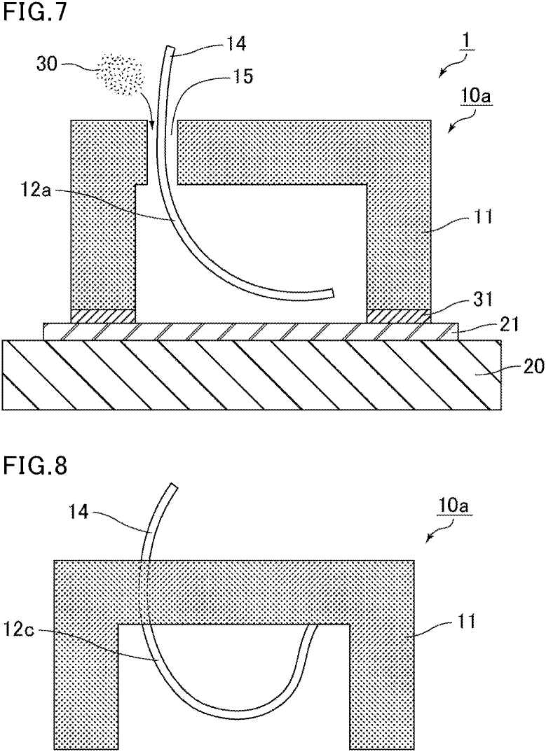

FIGS. 6 and 7 illustrate a method of applying a connector to a glazing according to some embodiments disclosed herein. As shown in FIG. 6, a connector 10a may be applied to a glazing 20 by positioning a conductive material 30 on a connecting surface 21 on the glazing 20; positioning the connector 10a including a housing 11 and a connector plate 12a within the housing 11 on the glazing 20 to enclose the conductive material 30 so that the connector plate 12a is spring loaded. Alternatively, as shown in FIG. 7, a connector 10a may be applied to a glazing 20 by placing the connector 10a including a housing 11 and a connector plate 12a within the housing 11 on the glazing 20 so that the connector plate 12a is spring loaded, filling the housing 11 with a conductive material 30 through an opening 15 in the housing 11, and sealing the opening 15 and a bottom edge of the housing 11 with a sealing 31.

FIG. 8 illustrates another embodiment of the connector. The connector 60 has a housing 11 and a connector plate 12c within the housing 11. The connector housing 11 is adhered to the connecting surface 21 on the glazing 20. An adhesive 62 may be provided on the bottom edge of the housing 11. The connector plate 12c may have an extension 14 which extends from the connector plate 12c out of the housing 11. As shown, the free end of the connector plate 12c is attached to the ceiling of the housing 11.

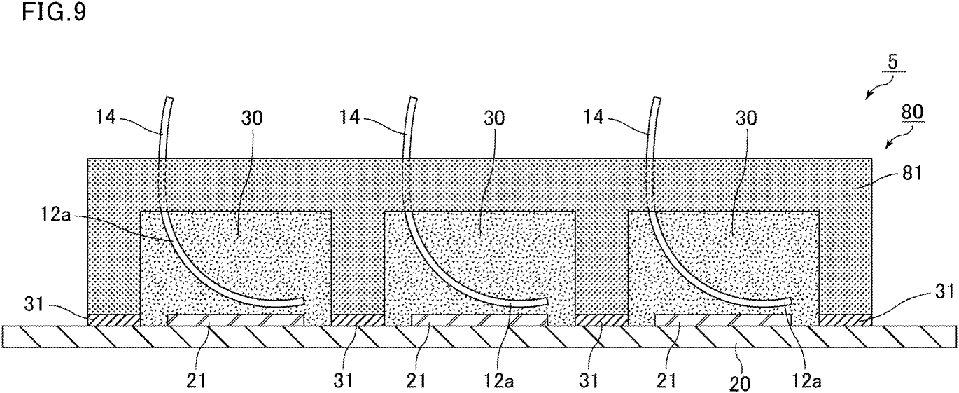

FIG. 9 illustrates another embodiment of the glass product. As shown in FIG. 9, the glass product 5 may have a connector 80 with a multiple-compartment housing 81 having at least two independent compartments, each of which includes a connector plate 12a and a conductive material 30. Each connector plate 12a may have an extension 14 as described above and may be electrically connected to the underlying connecting surface 21. A conductive material 30 may be positioned at least partially between the connector plate 12a and the connectable material 21.

Particular spatial terms such as “bottom” and “above” are used herein to describe the glass product or the connector in its orientation shown in the drawings and are not intended to be absolute.

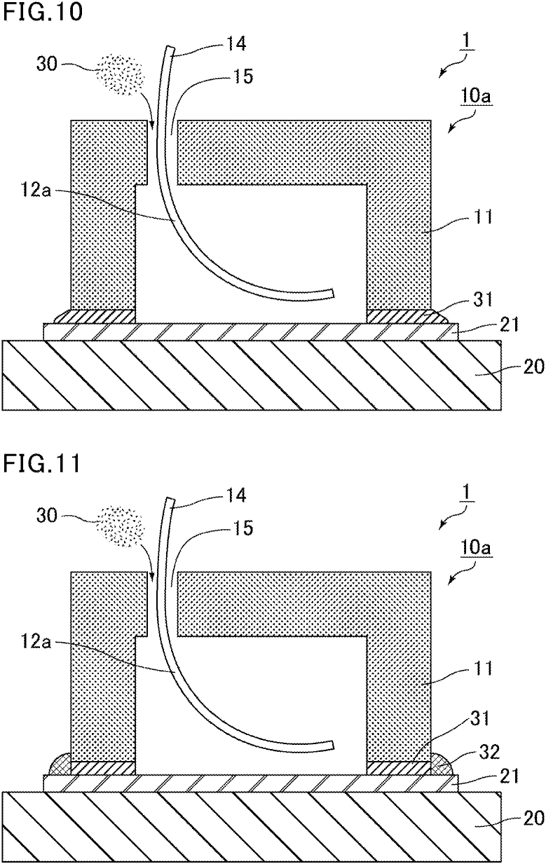

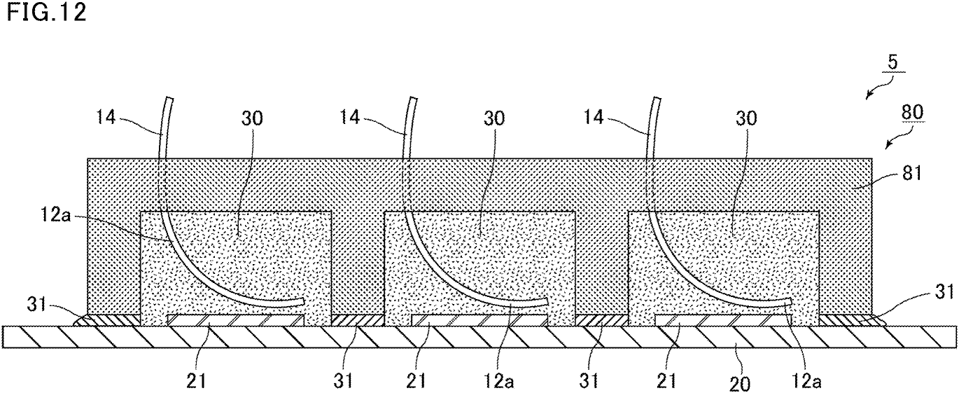

FIGS. 10 and 11 illustrate a method of applying a connector to a glazing according to some embodiments disclosed herein. In FIG. 10, the seal 31 is show spilling out from under the housing bottom surface. When the housing 11 is applied to the glazing, pressure may be asserted against the housing 11 which may cause the seal 31 to spill out. In FIG. 11, the seal 31 is positioned on the bottom of the housing and an additional seal 32 is provided at the edge of the housing. The additional seal 32 may be provided to support mechanical strength of the connector attachment. FIG. 12 illustrates another embodiment of the glass product. As shown in FIG. 12, a housing 81 having multiple compartments may have a seal 31 which may spill out from the housing bottom surface at an outer edge of the housing 81.

The above description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Further, the above description in connection with the drawings describes examples and does not represent the only examples that may be implemented or that are within the scope of the claims.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

1. A glass product, comprising:
a glazing having a connectable material with a connecting surface on the glazing;
a connector over the connecting surface including a housing, a connector plate within the housing, and an extension which extends from the connector plate through the housing; and
a conductive material paste within the housing,
wherein the connector plate is spring loaded.

2. The glass product according to claim 1, wherein the extension is a wire connection.

3. The glass product according to claim 1, wherein at least a part of the connector plate is buried in the conductive material.

4. The glass product according to claim 1, wherein the housing has at least one opening that is sealed.

5. The glass product according to claim 1, further comprising a non-conductive material within the housing.

6. The glass product according to claim 1, wherein the connector plate does not contact the connecting surface.

7. The glass product according to claim 1, wherein the connector plate does directly contact the connecting surface.

8. The glass product according to claim 1, wherein there are no air pockets within the housing.

9. The glass product according to claim 1, wherein the housing has no sharp corners in an interior of the housing.

10. A method of applying a connector to a glazing having a connectable material, the method comprising:
positioning a conductive material paste on a connecting surface for the connectable material on the glazing; and
positioning the connector including a housing and a connector plate within the housing on the glazing to enclose the conductive material so that the connector plate is spring loaded.

11. A method of applying a connector to a glazing having a connectable material, comprising:
placing the connector including a housing and a connector plate within the housing on a connecting surface for the connectable material on the glazing so that the connector plate is spring loaded;
filling the housing with a conductive material through an opening in the housing; and
sealing the opening and a bottom edge of the housing.

12. The method according to claim 10, wherein there is no air pocket in the connector applied to the glazing.

13. The method according to any one of the claims 10, wherein the housing includes an adhesive on a bottom surface of the housing.

14. The method according to claim 13, wherein the adhesive is a pressure sensitive adhesive.

15. The method according to claim 13, wherein the adhesive is an ultraviolet light curable adhesive.

16. The method according to claim 11, further comprising sealing a vent opening in the housing.
